(19) United States
(12) Patent Application Publication
(10) Pub. No.: US 2014/0061558 A1
(43) Pub. Date: Mar. 6, 2014

(54) LEVEL WINDING DRUM WINCH

(71) Applicant: Michael T. Einhorn, Seattle, WA (US)

(72) Inventor: Michael T. Einhorn, Seattle, WA (US)

(21) Appl. No.: 13/771,575

(22) Filed: Feb. 20, 2013

Related U.S. Application Data
(60) Provisional application No. 61/694,494, filed on Aug. 29, 2012.

(51) Int. Cl. B66D 1/39; B66D 1/02

(52) U.S. Cl. CPC B66D 1/39; B66D 1/02
USPC 254/331; 254/266; 254/342

(57) ABSTRACT

A level winding drum winch has a frame within which a rotatable drum is mounted. The frame is supported upon a pair of tracks upon which the frame may be slid from side to side. A motor connected to the drum rotates the drum for winding or paying out a cable wrapped around the drum. A feed screw attached within the frame is actuated by the motor to slide the frame from side to side as the cable is wound upon the drum. Thus, the cable is continuously directed at a substantially perpendicular angle, without bending or kinking, towards or away from the drum thereby forming a level winding and avoiding damage to the cable. The winch is particularly useful in handling relatively fragile composite cables useful for simultaneously towing and electronically communicating data with the objects towed by a boat.

### CROSS REFERENCE TO RELATED APPLICATIONS

This application is a completion application of co-pending U.S. Provisional Application Ser. No. 61/694,494 filed Aug. 29, 2012 for “LEVEL WINDING DRUM WINCH” the entire disclosure of which is hereby incorporated by reference.

### FIELD OF THE INVENTION

This invention relates to a drum type winch around which a cable is wound or from which the cable is payed-out or extended for towing an object or for raising or lowering a load, and communicating data to and from the towed object.

### BACKGROUND OF THE INVENTION

A conventional cable carrying winch generally comprises a horizontally arranged reel formed of a drum with side flanges mounted upon a horizontal axle or spindle. Cable is wound around the drum for storing the cable and is payed-out or extended from the drum for connection to other devices, such as for hoisting a load or towing an object behind the winch. Usually, a motor is connected to the reel for rotating the reel to thereby wind the cable about the drum. Conversely, the motor may be reversed to allow the reel to rotate in a direction which extends the cable.

Typically, a cable wound around the reel drum may be wound in a level manner; that is, with the loops of the winding side-by-side for leveling the windings upon the drum, by means of a leveling head. That device receives the cable as it is being wound upon the drum and moves from side-to-side as the drum rotates. The movement of the leveling device is synchronized with the drum rotation. In that manner, the successive windings or loops wind around the drum adjacent each other, side-by-side, to form levels or rows of windings upon the drum.

Such types of winches are commonly used in connection with boats or ships, such as for towing another object behind the boat, as well as for other purposes where communication-types of cables are utilized on land. Thus, in applications where there are many windings and layers of cable level-winding devices may be required in applying the successive windings or loops of the cable around the drum in a way to orderly store all the cable without damage and to carry the maximum number of windings upon the drum.

An example of such a self-leveling type of winch is disclosed in U.S. Pat. No. 3,815,846, issued Jan. 11, 1974 to Frank Biewer. That patent discloses a horizontally-arranged drum-type winch having a side-to-side leveling head which directs the cable along the length of the drum during the winding operation. The head in general utilizes a screw which moves a guide member to align the incoming cable to the drum, side-by-side of the preceding winding loop.

Because the use of leveling-directed mechanisms can introduce problems in the course of rewinding a cable upon a drum, attempts have been made to move the drum sidewise relative to a directing device so as to wind or direct the winding of the cable along the length of the drum. An example of this type of device is illustrated in U.S. Pat. No. 4,087,060, issued May 2, 1978 to Elmer Laky. This patent discloses mounting the drum on a horizontal axle and enabling the drum, by a secondary device, to move sideways, in a horizontal direction, as it receives successive loops or wraps of the incoming cable.

Some cables that are utilized in modern times may include cores formed of bundles of fiber optic strands, and insulation-coated thin wires, exterior coatings or layers, which have the strength to carry loads for use for towing an object as well as for communicating data through the cable. Where such cables are utilized, there may be a danger of possible damage to the cable during the winding operation where the cable may become bent sharply or kinked. In such instances, the cable can be damaged or its interior core materials can be damaged. Thus, such cables are relatively fragile and particularly where used in a towing operation, such as towing an object behind a vessel on water, reeling in the cable through a directional winding head or a moveable reel can cause unintended damage or reduce the useful life of the cable.

Thus, the invention of the present application is concerned with providing a self-leveling winding winch which is particularly useful for cables which are susceptible to contact damage by fair leading equipment or are subject to contact damage by fair leading equipment or are subjected to heavy forces or tensions of towing as well as functioning as data communication connectors to a towed object. Further, this invention relates to a cable-carrying and rewinding system that is useful for both towing and data communication, in which the winding reel is stably mounted against unintended movements which could be experienced on a boat or on a vehicle of some sort carrying the reel.

### SUMMARY OF THE INVENTION

The invention herein, in general, comprises a horizontally arranged drum-type reel which is rotatably mounted within a support frame. The reel is not moveable from side-to-side but rather is arranged to rotate in response to a motor power arrangement. However, the frame itself, with the reel mounted within the frame, is arranged to move from side-to-side in synchronism with the winding of the cable around the drum of the reel.

The frame is secured to a base, such as the deck of a boat or ship or the bed or frame of a vehicle such as a truck, in a manner so that it cannot be displaced easily from side-to-side or front-to-back during the forces of a tow or movements of the carrying vessel or vehicle. Yet, the frame is synchronized and automatically moved from one side to the other, reciprocating, to receive cable windings in a leveling arrangement.

More specifically, it is contemplated to mount the frame upon a pair of separated guide bars or by tracks or rails by mounting devices which permit the frame to be moved from side-to-side and yet prevent the frame from tipping in any direction relative to the guide bars. The frame is then moved in synchronism with the application of the windings by means of a lead screw mechanism which is synchronized to the rotation of the reel and which reverses the direction of movement of the frame from one side to the other as the layers of windings are applied to the drum.

An object of this invention is to provide a self-leveling drum-type winch which comprises a frame within which the reel is mounted immovably, except, of course, for rotation, but the frame may be moved from side-to-side for leveling the coils of the cable and yet is held against displacement from the deck or platform upon which the equipment is mounted.

Another object of this invention is to provide a relatively inexpensive, compact self-leveling drum which can be easily mounted upon a mobile device, such as a boat deck or a land vehicle and allow for rotating movement of the winding reel but otherwise prevent the reel from being displaced or detached from its support in response to towing or pulling forces.

Yet another object of this invention is to provide a relatively inexpensive construction with limited moving parts that enable the winding of a reel in a self-leveling manner, without complications in operating the device.

These and other objects and advantages of this invention will become apparent upon reading the following description of which the attached drawings form a part.

### DESCRIPTION OF DRAWINGS

The drawings described herein are for illustrative purposes only of selected embodiments and not all possible implementations, and are not intended to limit the scope of the present disclosure.

FIG. 1 schematically illustrates the winch structure mounted upon the deck of a boat or ship with a cable extending from the winch to an object that is towed behind the boat.

FIG. 2 is a cross-sectional, schematic view of the winch and its mounting structure.

FIG. 3 is an exploded, schematic view illustrating the reel separated from its support frame and the support frame separated from its mounting guide bars.

FIG. 4 is a more enlarged perspective view of the winch.

FIG. 5 is a perspective, schematic or cutaway view of the lead or feed screw mechanism which causes the frame to move from side-to-side in response to the rotation of the reel.

FIG. 6 is a cross-sectional, schematic view of the lead screw and the shuttle engaged with the screw.

FIG. 7 is a perspective, fragmentary view of the shuttle connector part which engages the feed screw.

FIG. 8 is an enlarged perspective view showing the ratchet and pawl arrangement for securing the reel and preventing an unwanted rewind of the cable after it has been extended.

Corresponding reference numerals indicate corresponding parts throughout the several views of the drawings.

### DETAILED DESCRIPTION

The system will now be described more fully with reference to the accompanying drawings.

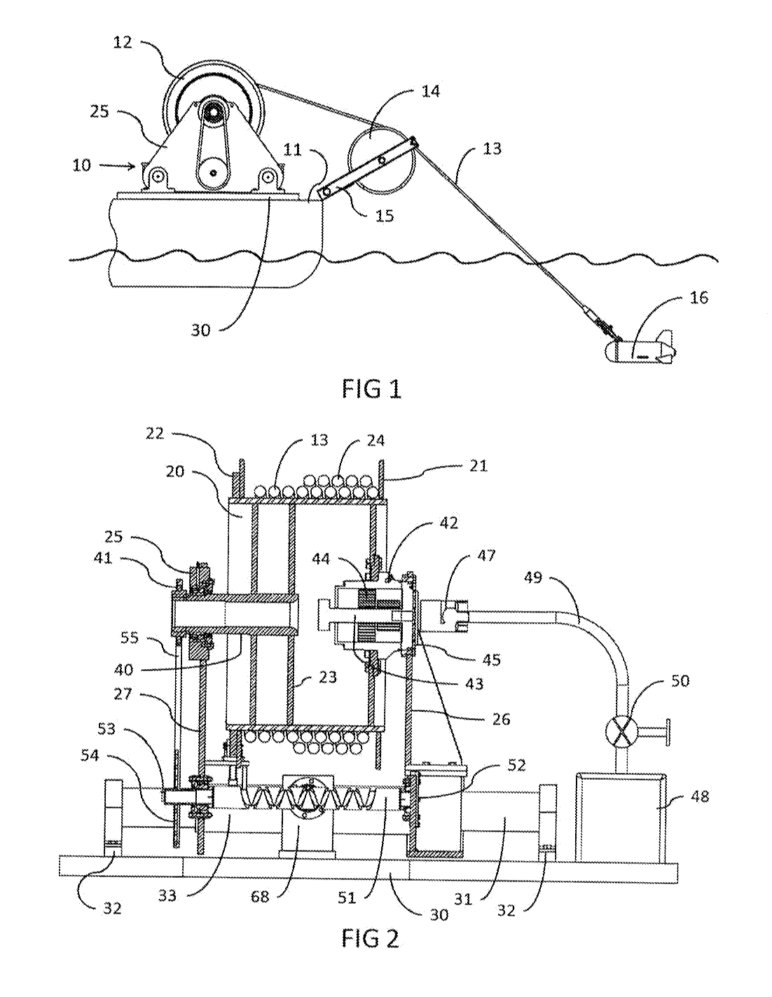

FIG. 1 schematically illustrates a winch system 10 secured upon the deck 11 of a boat or ship (schematically illustrated in part). The reel 12 holds the cable 13 which is fed through a guide roller 14. The roller is fixedly supported by a roller support member 15 to guide the cable outwardly of the boat. The cable is shown as connected to an object 16, such as another boat, or an underwater device, such as a container holding various measuring instruments or even a submersible-type of device for holding one or more persons or measuring instruments. This illustrates schematically a use of the winch in towing an object. The winch could be mounted upon the bed or frame of a truck or other vehicle and the towed object could be anything being towed by the vehicle or lifted or lowered by the cable.

While any type of cable could be wound around the drum 20, the winch is especially useful in handling conventional electro-mechanical cables which can serve the function of both towing or pulling or resisting a heavy drag force and simultaneously conveying communications. For example, the cable might be formed with numerous fiber optic strands properly insulated as well as other insulated electronic conveying strands of copper or the like, surrounded by an outer casing which in turn is surrounded by a shielding or covering which is strong enough to resist anticipated forces on the cable. Such cables typically have a relatively large bend diameter requirement and can be damaged by too sharp bends in winding on unwinding procedures.

Turning to FIG. 2 of the drawings, the winch system is illustrated schematically in cross-section. The winch comprises the drum 20 which has opposite-side flanges 21 and 22 and a central, interior, reinforcing panel 23. Cable windings or loops 24 are illustrated surrounding or wound upon the drum.

The drum is rotatably mounted within a frame 25. The frame is formed of opposite frame walls or panels 26 and 27 which are spaced apart and arranged on opposite sides of the reel flanges.

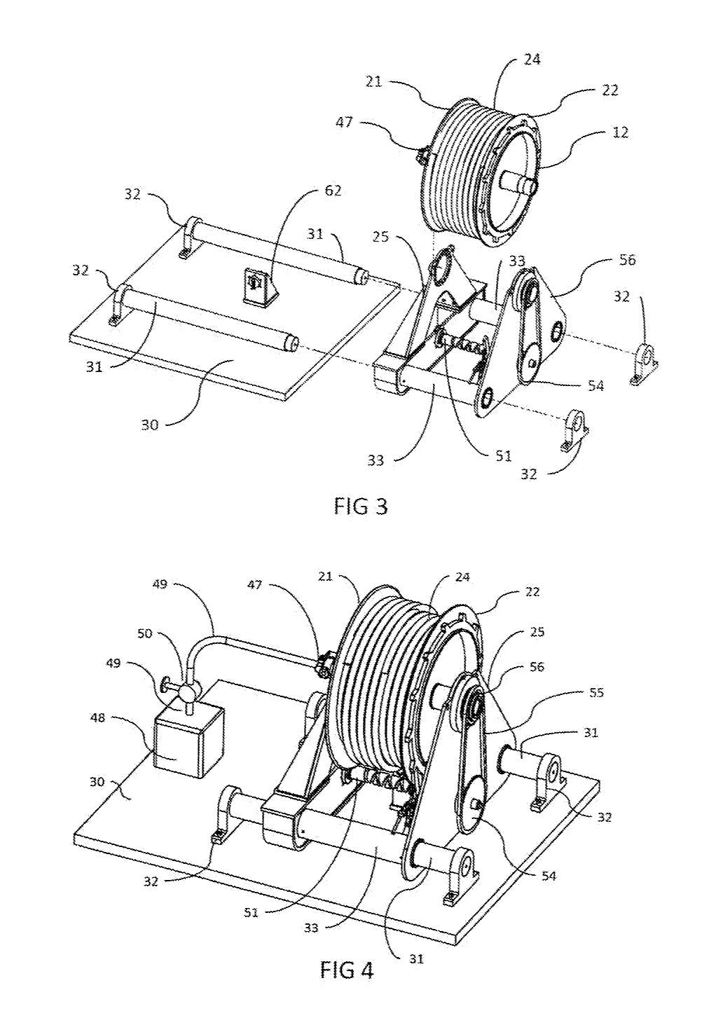

The frame is connected and supported upon a platform 30, which could be the deck of a vessel or a bed of a truck or the like where a winch of this type may be used. The frame is slideable from one side to the other. That is, the frame is supported upon a pair of guide bars or rails 31 which are secured upon the platform 30 by means of end supports 32. Preferably the rails are cylindrical or circular in cross-section and are raised a short distance above the platform surface. The lower ends of the opposed frame walls are connected together by means of a tubular slider 33 (FIGS. 3 and 4) through which the rails slideably fit. Hence, the frame may be moved sideways with their tubular connecting portions sliding one way or the other upon the rails. Thus, the tubular connecting members 33 form a base which comprises the two spaced-apart slide members each positioned upon one of the guide bars.

The reel is supported on the frame by a pair of spindles. One spindle 40 extends through the frame wall 27 and the adjacent reel flange, to which it is connected. Outwardly of the frame a gear or sprocket 41 is mounted on the end of that spindle. Thus, as the spindle rotates with the reel, the gear or sprocket on the end of the spindle rotates.

The opposite spindle is formed of the housing 42 of a gear box which is commercially available for use in operating winch reels. By way of example, one commercially available gear box that can be utilized in rotating winch reels is commercially referred to as the “Rextroth, Bosch Group, winch drive mobile GFT-W.” Other such drives are available and can be selected by those skilled in the art.

The gear box or gear housing 42 has a reduction gear set 44 configured in a planetary arrangement. In this arrangement an outer ring gear is integral to the rotating gearbox housing 42. A fluid motor 47 powers a central sun gear though a drive shaft 43. Through the planetary gears 44, this causes the housing 42 to rotate. The rotating gear housing supports and rotates the reel. This construction is conventional or otherwise commercially available. The device includes a housing cover 45 which is fastened to the frame wall and is arranged so that the gear housing may rotate while the cover is secured to and remains stationary on the frame wall 26.

To power the fluid motor 47, which may be hydraulic or pneumatic, a pump and reservoir or compressed air source 48 is arranged near the equipment and connected by a transmission line 49 to the motor. Suitable valves 50, schematically illustrated, may be used to control the flow of the drive fluid and thus the motor which in turn rotates the shaft 43 to turn the interior gears within the gear housing to rotate the housing.

As mentioned, the reel rotates but does not otherwise move relative to the frame. However, the frame is synchronized with the rotation of the drum so that the frame, containing the reel, moves from side-to-side, sliding back and forth upon the guide bars. This movement of the frame is controlled by a lead or feed screw 51 which extends between the frame side panels or walls. As shown in FIG. 2, one end of the screw is journaled or rotatably held at its end 52 at one wall. The opposite end of the screw extends at 53 outwardly of the opposite wall of the frame and carries a gear or sprocket and clutch 54. A chain 35 connects the sprocket of the screw with the sprocket on the spindle 40 so that the screw is rotated in synchronism with the rotation of the reel. Schematically, only a pair of sprockets is shown for driving the screw from the spindle. However, other sprockets or cooperating gears may be inserted between them to obtain the desired speeds or rotation of the spindle and its connected reel. In addition, in practice, it would be desirable to have a conventional clutch mechanism for disengaging the lead screw drive or for releasably connecting the two sprockets together so that the spindle can be inactive when not in use and conversely connected for use in moving the frame. Thus, the drum may be rotated independently of the lead screw drive for timing purposes.

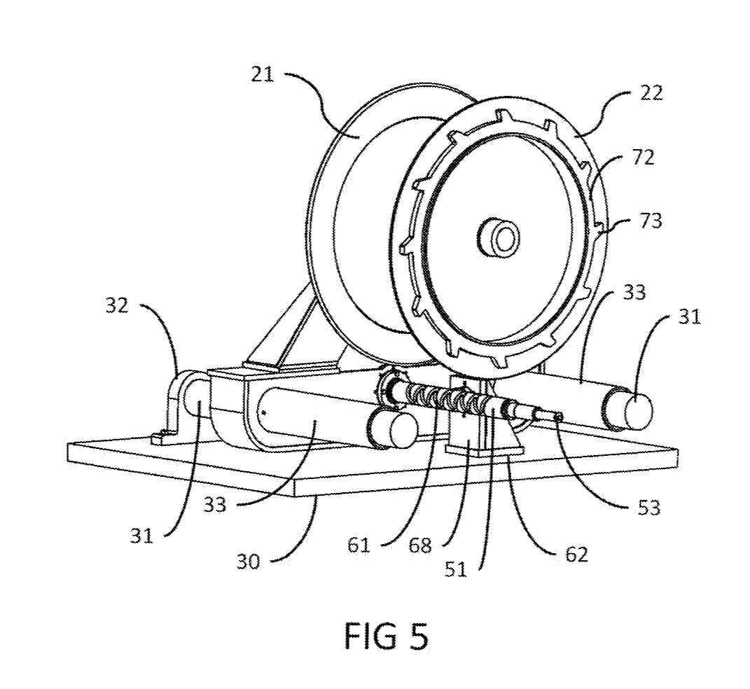

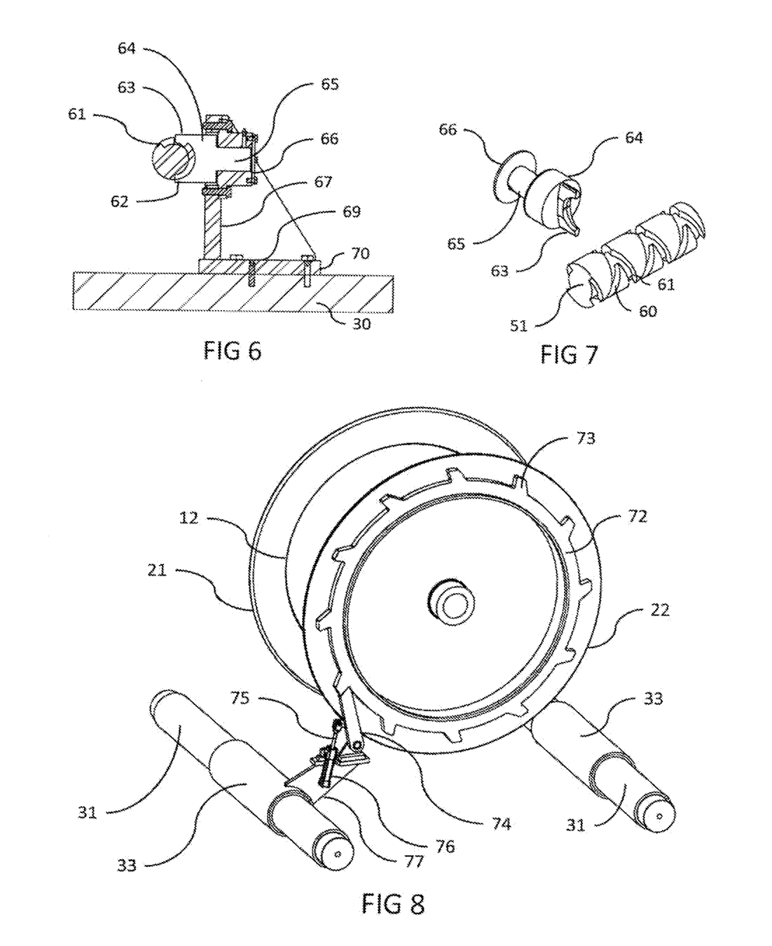

The lead screw is provided with a diamond-shaped or crossed threads or channels 60 and 61 (FIGS. 5 and 7) so that the reel may rotate in one direction and a fixed follower or shuttle 62 engages with one or the other of the channels for advancing this screw in one direction or the other. FIG. 6 illustrates the engagement between a shuttle, which has a blade (see FIG. 7) that engages within one or the other of the two threads or channels on the screw. The shuttle has a blade 63 mounted on a blade head 64 formed on a short stub shaft 65 (FIG. 6). The shaft has an enlargement 66 on its end so that the blade holder 67 holds the shuttle blade and permits the blade head to turn or rotate slightly as the blade enters one or the other of the channels formed on the screw. The device is supported upon a support 68 having a lower flange 69 which may be bolted, at 70, to the platform 30.

Referring to FIG. 8, a ratchet is provided for the reel in order to permit the reel to rotate in the unwinding or extending direction but holding it against rewinding when rewinding is undesirable, such as during a towing operation. The ratchet is formed of a large ring 72 having peripheral teeth 73 which are engaged by a pawl lever 74. That lever is actuated by a rod 75 that extends into a cylinder 76, which is attached to a support member 77 connected to the adjacent part of the tubular slider 33. The pawl lever can be manually actuated when desired. When the pawl is engaged with the ratchet, the reel is prevented from paying out the cable.

Because the reel is essentially immovable, except for rotation, relative to its supporting frame, but can be shifted sideways one way or the other, it can be moved easily into alignment with the incoming cable during the winding of the cable. Thus, the cable aims to the reel approximately perpendicular to a drum radius that is slightly at an angle due to the spiral winding. Hence, the cable is able to avoid sharp bends or high contact stresses which might otherwise occur. In addition, the point of winding upon the drum is always in one position relative to the face width of the drum so that the effective fleet angle is always zero. This provides the ideal path between the winch and the deployment roller 14 (FIG. 1).

The cable is protected against internal damage and also limits the amount of contact or rubbing each cable loop has with adjacent loops during the wind-up or wound-out process. Further, the simplicity of the parts for sliding the frame sideways simplifies the operation of the system. Particularly, the tubular connection between the bars inserted through the tubes prevents the frame from tipping forwardly or backwardly or sideways relative to the platform upon which the frame is mounted. In the case of use of this equipment on a moving boat or ship or truck, this stability is significant. Summarizing, the connection between the reel, via its frame mounted on guide bars which extend through the tubular connectors which are formed as the bottom part of the frame, guarantees against unwanted motion of the equipment in all directions relative to its supporting platform.

This invention may be further developed within the scope of the following claims. Accordingly, having fully described an operative embodiment of this invention, I now claim.

What is claimed is:

1. A level winding drum winch having a horizontally axised, rotatable reel upon which a cable is wound and from which the cable is payed-out comprising:
a frame having a pair of vertical, spaced apart walls with the reel arranged between, and rotatably connected to, the walls,
said walls having lower portions connected together by spaced apart slide members; and a pair of horizontal, spaced apart guides arranged below the frame parallel to the axis of the reel, with the guides being longer than the distance between the walls and the frame slide members engaging the guides for reciprocating the frame, and simultaneously the reel connected thereto, together sideways a distance about equal to the length of the reel,
a motor connected to the reel for rotating the reel for thereby winding or unwinding loops of the cable upon or off the reel,
a bi-directional feed screw engaged with the frame for moving the frame from side to side and said screw being synchronized with the rotation of the reel for advancing the reel sideways an amount about equal to a cable width for winding or unwinding each loop of the cable that encircles the reel,
whereby the cable is directed substantially perpendicular to the reel when wound or unwound and is level wound upon the reel.

2. A level winding drum winch as defined in claim 1, and including said slide members being formed of elongated tubes extending between and connected at their opposite ends to their adjacent frame wall portions;
each of said slide members receiving a guide extending therethrough and arranged outwardly of the opposite ends of the slide members;
whereby the frame may be slid sideways upon the guides in response to the movement of the feed screw.

3. A level winding drum winch as defined in claim 2, and including said guides each being formed of an elongated, substantially uniform cross-sectional cylinder;
each of the guides being closely and slideably fitted within a tubular slide member;
whereby the slide members, with the attached frame and reel, may be moved from side to side but the frame is otherwise prevented from movement in any other direction relative a platform upon which the frame is mounted;
and the guides being secured normally upon the platform by fasteners which position the guides a short distance above the platform.

4. A level winding drum winch as defined in claim 3, and including said feed screw being formed with a diamond pattern of crossing channels along its length and opposite ends of the screw being journaled within openings formed in each of the frame walls and the screw being fixed immovably endwise relative to each of the walls in which they are journaled except for rotation of the screw;
a fixed shuttle member secured to the platform beneath the frame and engaging with a portion of one of its channels whereby rotation of the screw relative to the fixed shuttle advances the screw endwise in one direction or the opposite direction for thereby reciprocating the shuttle; and
including one end of the screw being connected to the reel for synchronizing the sidewise movement of the frame with the rotation of the reel and screw to level winding of the cable on the reel.

5. A level winding drum winch having a horizontally axised, rotatable reel upon which a cable is wound and from which the cable may be payed-out and rewound, comprising:
a frame having a pair of vertical, spaced-apart walls within which the reel is arranged, with the reel being connected to the walls by a spindle so that the reel may be rotated relative to the walls,
said walls having lower portions connected together by a pair of horizontally spaced-apart tubular slide members;
a platform arranged beneath the frame and a pair of horizontally spaced-apart tracks mounted upon the platform, and beneath the frame, with the tracks being parallel to the axis of the reel and positioned within the tubular slide members which may slide sideways to one side or the other upon the tracks, with the tracks being longer than the distance between the walls;
a feed screw arranged beneath the reel and rotatably connected at opposite ends to each of the walls for rotation about an axis parallel to the axis of the reel and a shuttle fixedly mounted on the platform and engaging the feed screw whereby rotation of the screw moves the frame from one side to the other and back when the screw is rotated;
a motor connected to the reel spindle and the reel spindle being operably connected to the screw for synchronizing the rotation of the screw to the rotation of the reel for thereby slideably moving the reel during each rotation of the reel to level a cable being wound upon the reel;
whereby the cable may be directed, during rewinding, substantially perpendicular towards a radius of the axis of the reel as it is wound or unwound from the reel.

6. A level winding drum winch as defined in claim 5, and including said tracks being formed of elongated, substantially uniform cross-sectional cylinders;
said cylinders being closely and slideably inserted through the tubular slide members for holding the frame upon the platform and preventing all movements of the frame except the sidewise sliding movements thereof.

7. A level winding drum winch defined in claim 6, and including said reel having a flange on each side of the drum forming the winch with the flange being of greater diameter than the drum upon which the cable is wound;
a ratchet ring secured against the outer face of one of the flanges, that is, between the flange and the frame wall;
outwardly extending teeth formed along the peripheral edge of the ring;
a pawl lever mounted fixedly beneath the reel and being moveable towards and away from the periphery of the ring for engaging a tooth when the lever is moved in an extended position and thereby locking the reel against rotation and alternatively removing into a position spaced from the peripheral piece of the ring for avoiding stopping rotation of the reel.

8. A self-leveling drum winch having a horizontally axised drum having side flanges at opposite ends of the drum, with the drum normally holding a cable wound around it for paying-out the cable and rewinding the cable as desired;
the drum being mounted upon a rotatable spindle, and the reel being located within a frame having sidewalls spaced apart with the reel located between said walls and rotating relative to the frame walls;
the frame walls being connected together by a pair of tubular slide elements connected at their opposite ends to the sidewalls and horizontally spaced apart and located beneath the reel;
the frame being normally mounted above a platform;
a pair of spaced-apart guide bars mounted upon the platform and inserted through the tubular connectors with the bars being of substantially greater length than the distance between the frame walls so that the frame may be slid sideways upon the bars during the rewinding of a cable upon the reel;
said bars being mounted above the platform by end supports;
a lead screw connected at its ends to the walls and extending between the walls, and a shuttle immovably fixed and engaging the threads of the lead screw whereby rotation of the screw moves the frame horizontally in one direction and then reversely to the opposite direction;
a motor rotating the spindle and therefore, the reel with the motor being operatively connected to the lead screw for synchronizing the rotation of the screw and screw and the sideway movements of the frame with the rotation of the reel for level winding the cable upon the reel.

9. A winch as defined in claim 8, and including said lead screw having a diamond pattern of threads; that is, threads operating in one direction and crossing threads operating in an opposite direction whereby the fixed shuttle engages-with the threads alternatively and causes the screw to move and thereby move the frame accordingly in a sidewise direction and then a reverse direction.

10. A winch as defined in claim 9, and including the drum being mounted upon a spindle connected to one of the flanges and a separate spindle-like member comprised of the housing of a gear arrangement with the housing rotating in response to a shaft extending through the housing and the adjacent frame wall for connection to a drive motor whereby the housing rotates the reel through its connection to the flange of the reel; whereby the gear system for driving the rotation of the reel is enclosed within the drum.
